(19) United States
(12) Patent Application Publication
(10) Pub. No.: US 2026/0130534 A1
(43) Pub. Date: May 14, 2026

(54) LIQUID HEATING APPLIANCES

(71) Applicant: Strix Limited, Ronaldsway (GB)

(72) Inventors: David H. Powell, Loxwood (GB); Neil Martin Baron, Brighton (GB); Joshua King, Woking (GB); Christopher Kay, Douglas (GB); Marc Collinson, Crosby (GB); Richard Fumagalli, Chester (GB)

(21) Appl. No.: 19/119,032

(22) PCT Filed: Oct. 6, 2023
(86) PCT No.: PCT/GB2023/052599

§ 371 Date: Apr. 7, 2025

(30) Foreign Application Priority Data
Oct. 7, 2022 (GB) 2214807.6

(51) Int. Cl. A47J 27/21; H05B 1/02

(52) U.S. Cl. CPC A47J 27/2105; A47J 27/21083; A47J 27/21166; H05B 1/0269

(57) ABSTRACT

A liquid heating appliance includes a liquid vessel and a power base configured to supply electrical power to the liquid vessel when the vessel is arranged thereon. The appliance further includes a user interface, for setting an operational mode of the liquid heating appliance. The user interface includes a rotatable ring which extends 360 degrees around the liquid heating appliance and a detection means configured to detect the position of the rotatable ring. The position of the rotatable ring determines the operational mode of the liquid heating appliance.

This application is entitled to the benefit of, and incorporates by reference essential subject matter disclosed in PCT Application No. PCT/GB2022/052599 filed on Oct. 6, 2023, which claims priority to GB Patent Application No. 2214807.6 filed Oct. 7, 2022, which are hereby incorporated by reference in their entireties.

### BACKGROUND OF THE INVENTION

### 1. Technical Field

The present invention relates to liquid heating appliances, for example liquid heating appliances comprising a liquid vessel supported on a power base.

### 2. Background Information

When heating water to prepare a hot beverage, the optimal temperature to which the water is heated may depend on the beverage being prepared. For example, black tea is ideally brewed with water heated to a temperature of 95° C., whereas green tea is ideally brewed using water heated to 80° C. In contrast, coffee is ideally brewed using water heated to around 90° C. As such, many hot beverage consumers desire the ability to heat water to different temperatures in order to obtain water at an optimal temperature for brewing a particular beverage of choice. To meet this demand, some liquid heating appliances are capable of heating liquid to different temperatures so as to be suitable for use in preparing different hot beverages. The temperature to which the liquid is heated is typically selectable by a user. In order to facilitate such selection, such appliances often comprise a plurality of buttons which allow selection of the temperature to which the appliance heats its contents. A user selects their desired temperature by operating the buttons, and the appliance then heats the volume of liquid contained therein to the selected temperature.

In prior art appliances of the type described above, the number of selectable temperatures may be limited by the number of buttons present. Further, the angular position around the appliance at which the buttons can be feasibly reached, and thus operated, is also limited. As a result, such appliances may need to be orientated at a specific orientation on a work surface in order for a user to be able to feasibly operate the buttons.

The present invention aims to address or at least mitigate at least one of the problems outlined above.

### SUMMARY

When viewed from a first aspect, the present invention provides a liquid heating appliance comprising: a liquid vessel; a power base configured to supply electrical power to the liquid vessel when the vessel is arranged thereon; and a user interface, for setting an operational mode of the liquid heating appliance, comprising: a rotatable ring which extends 360 degrees around the liquid heating appliance; and a detection means configured to detect the position of the rotatable ring; wherein the position of the rotatable ring determines the operational mode of the liquid heating appliance.

The rotatable ring may thus be rotated in order to select the operational mode of the liquid heating appliance. It is thus the rotational position of the rotational ring which sets the operational mode of the appliance. As the rotatable ring extends 360 degrees around the liquid heating appliance, a user may rotate the rotatable ring, and thus select the operational mode of the liquid heating appliance, from any position around the liquid heating appliance. As such, the liquid heating appliance may be positioned on a work surface in any orientation and a user may nonetheless be able to operate the appliance appropriately. Further to the above, the presence of a rotatable ring which extends around the appliance (as a means for selecting an operational mode of the liquid heating appliance) may reduce the overall footprint of the appliance, as the need to provide mode selection buttons on a surface of the power base may, for example, be avoided.

Additionally, as the rotatable ring extends around the entire liquid heating appliance, it may be possible to enable a larger number of operational modes to be selected by the rotatable ring. For example, the rotatable ring may be able to rotate 360 degrees around the appliance. As an example, every 3 degrees of rotation of the rotatable ring may correspond to a different mode of operation. In this example, there may be 120 different modes of operation that can be selected using a single component, specifically the rotatable ring. Each of the modes may correspond to a different temperature to which the appliance heats the contents of the liquid vessel. In addition, or alternatively, the rotatable ring may allow operational modes to be selected more accurately. The potential for a relatively large range of rotatable movement of the rotatable ring may make it easier for a user to accurately select an operational mode as the angular range of the rotatable ring which corresponds to a given operational mode may be relatively large.

The rotatable ring may have any suitable form so long as it is arranged to rotate around the appliance. In some embodiments, the rotatable ring rotates around an axis extending through a centre of the power base and/or a centre of the liquid vessel. As the rotatable ring extends around 360 degrees around the appliance, the rotatable ring may be considered to extend around the entire appliance and/or extend around the entire periphery of the appliance. The rotatable ring may comprise an outer peripheral portion and a disc-shaped portion, having a hole therein, extending inwards of the outer peripheral portion.

The operational mode of the liquid heating appliance is the mode in which the appliance operates. The types of operational mode which are selectable by the rotatable ring may depend on the particular application of the liquid heating appliance, e.g. the type of liquid it is intended to heat and for what purpose the heated liquid is required. The liquid heating appliance may thus be capable of operating in a plurality of different operational modes. In a set of embodiments, the operational mode of the appliance comprises at least one of: a temperature mode, a keep warm mode, and a heat and cool mode.

A temperature mode may correspond to the temperature to which liquid in the liquid vessel is heated. The temperature mode may comprise a plurality of different temperature modes, each temperature mode corresponding to a different temperature. For example, a user may rotate the rotatable ring in order to set the temperature mode to which the liquid in the appliance is to be heated. For example, the appliance may comprise a number of different temperature modes: e.g. 80° C., 85° C., 90° C., 95° C. and 100° C. The position of the rotatable ring may thus set the temperature mode to that which the liquid vessel heats a liquid contained therein. The keep warm mode may correspond to an operational mode whereby the appliance is configured to keep the contents of the liquid vessel at a pre-set temperature, or within a pre-set temperature range, following initial heating of the contents of the liquid vessel. The keep warm mode may also comprise a timed keep-warm mode, whereby the keep warm mode is set to operate for a predefined period of time.

The heat and cool mode may correspond to an operational mode whereby the liquid in the liquid heating vessel is heated, e.g. boiled so as to sterilise the liquid, and then left unheated to cool, e.g. naturally, until it reaches a predetermined temperature. Following heating and subsequent cooling, the liquid in the appliance may then optionally be heated occasionally in order to maintain it at this pre-determined temperature. In this way, the appliance may then operate in a form of keep warm mode. When the appliance is used to heat water, this heat and cool mode could be used to prepare water for use when making baby formula milk feed. In such embodiments, the temperature to which the liquid is heated, prior to being allowed to cool, may be boiling, e.g. 100° C. for water.

In other embodiments, the operational mode may comprise a timed-mode, whereby the appliance operates according to a specific time. For example, the appliance may operate to heat liquid for a set period of time. The timed-mode may comprise a plurality of different time modes, each having a different time for which the appliance is operated according to a specific function or mode.

The user interface may be located at any suitable position on the liquid heating appliance such that it can be operated by a user. In a set of embodiments, the rotatable ring is arranged on the power base and arranged to rotate around the power base. The detection means may also be arranged together with the rotatable ring on the power base. As the power base may rest on a work surface, arranging the rotatable ring on the power base, and thus proximal to the work surface, may be the most stable place on the appliance to arrange the rotatable ring. Arranging the rotatable ring in such a stable position may reduce the likelihood of the user tipping over the appliance when operating the rotatable ring. In further embodiments, the entire user interface may be arranged on the power base. Arranging the user interface on the power base may be advantageous as the power base may be constantly supplied with electrical power, e.g. through suitable connection to a power supply. As such, the user interface may be constantly supplied with electrical power, irrespective of the position of the liquid vessel, i.e. irrespective of whether it is placed on, or separated from, the power base. In embodiments wherein the user interface comprises an indicator means (discussed further below), such an indicator means may continuously be supplied with power and thus remain functional irrespective of the position of the vessel. In some embodiments, the rotatable ring may be arranged on the power base, and other components of the user interface, e.g. an indicator means (described in more detail further below), may be arranged on another part of the appliance e.g. on the liquid vessel. In this way, the user interface may be split between the power base and the liquid vessel.

In a further set of embodiments, the rotatable ring at least partially defines a recess in the power base and wherein said recess is shaped to receive a lower part of the liquid vessel when the liquid vessel is arranged on the power base. The recess may be at least partially defined by an outer peripheral portion of the rotatable ring. The presence of such a recess may help to guide placement of the liquid vessel on the power base, and thus improve the ease of use of the appliance.

In embodiments wherein the rotatable ring is arranged on the power base and thus extends around the power base, the rotatable ring may be arranged at any point along a height of the power base. However, in a set of embodiments, the power base comprises a main body, and wherein an upper portion of the main body is arranged above the rotatable ring so as to contact the liquid vessel when the liquid vessel is arranged on the power base. Accordingly, when the liquid vessel is seated on the power base, the liquid vessel will contact the upper portion of the main body, rather than contacting the rotatable ring. Avoiding direct contact with the rotatable ring may help to ensure that the rotatable ring is free to rotate when the liquid vessel is arranged on the power base. The main body may comprise multiple sub-parts which are attached together, and the upper portion of the main body may comprise an upper sub-part of the main body. The rotatable ring may be arranged on the power base such that vertical forces applied by a vessel seated on the power base are not transferred (or substantially not transferred) to the rotatable ring. The main body of the power base may comprise multiple sub-parts which together form the main body. The main body may further comprise a lower portion which is arranged to rest on a work surface, during use of the appliance. The upper portion, lower portion and rotatable ring may be arranged such that when the liquid vessel is seated on the power base, and thus contacts the upper portion, the weight of the liquid vessel is transferred from the upper portion to the lower portion, without transferring the weight to the rotatable ring. This may ensure that the rotatable ring remains free to rotate. The upper portion may be arranged to rest directly on the lower portion.

It is not essential for the rotatable ring, or indeed the entire user interface, to be arranged on the power base. The rotatable ring, or the entire user interface, may be arranged at any suitable position on the appliance. Accordingly, in alternative embodiments, at least the rotatable ring is arranged on the liquid vessel. The detection means may also be located on the liquid vessel. Arranging the rotatable ring on the liquid vessel, optionally along with other features of the user interface, may mean that the appliance is simpler and potentially less expensive to manufacture as a need to transfer data from the vessel to the power base may not be required. Accordingly, the form of a power connector arranged between the base and the vessel may be simplified.

In a further set of embodiments, the entire user interface may be arranged on the liquid vessel. The rotatable ring, or indeed the entire user interface, may be arranged at any suitable position on the liquid vessel. In a set of embodiments, the rotatable ring is arranged at a lower end of the liquid vessel or an upper end of the liquid vessel. Similarly to the embodiments described above, the entire user interface may be arranged at a lower end or an upper end of the liquid vessel. The rotatable ring may be arranged at the lower end, e.g. the bottom, of the liquid vessel. As such, the rotatable ring may extend around a lower portion of an outer wall of the liquid vessel. Alternatively, the rotatable ring may be arranged at an upper end of the liquid vessel such that the rotatable ring extends around the upper portion of an outer wall of the vessel. Arranging the rotatable ring on such an upper part of the outer wall of the liquid vessel may place the rotatable ring in a position which is convenient to access for a user. In embodiments wherein the rotatable ring, as well as associated control electronics, or indeed the entire user interface, are arranged on the liquid vessel, a power supply may be arranged in the liquid vessel to supply the electronics with power when the liquid vessel is separated from the power base. Accordingly, the user interface may continue to function even when the liquid vessel is separated from the power base. In other embodiments, the rotatable ring may be arranged on the liquid vessel, and other components of the user interface, e.g. an indicator means (described in more detail below), may be arranged on the power base. In such embodiments, the user interface may be split between the liquid vessel and the power base.

The rotatable ring may be arranged on the liquid vessel in any suitable manner. In a set of embodiments, the liquid vessel comprises a main body, and wherein a portion of the main body is arranged below the rotatable ring so as to contact the power base when the liquid vessel is arranged thereon. As such, the portion of the main body will contact the power base, when the vessel is arranged thereon. This means that the rotatable ring is not contacted by the power base and is therefore not inhibited from rotation when the liquid vessel is placed on the power base. The rotatable ring may be arranged on the liquid vessel such that vertical forces transferred through the liquid vessel are not transferred (or substantially not transferred) to the rotatable ring. In a similar manner to the embodiments described above with respect to the power base, the portion of the main body arranged below the rotatable ring may be arranged to transfer vertical forces (e.g. when seated on the power base), through to the rest of the liquid vessel without transferring said force to the rotatable ring. The rotatable ring may thus remain free to rotate.

The rotatable ring may comprise an outer surface which a user contacts in order to rotate the rotatable ring around the appliance. In a set of embodiments, the rotatable ring comprises at least one grip feature arranged thereon. The at least one grip feature may be arranged on an outer surface of the rotatable ring such that it can be contacted by a user during operation. The at least one grip feature may comprise a plurality of grip features. The grip feature(s) may have any suitable form. For example, the grip feature(s) may be in the form of a plurality of ribs extending axially along an outer surface of the rotatable ring. The grip feature(s) may be provided by any other suitable means. For example, the grip feature(s) may comprise a textured surface provided on an outer surface of the rotatable ring. The textured surface may increase the friction when a user applies a force to rotate the ring, and thus facilitate gripping of the rotatable ring. In other embodiments, the appliance may comprise an input means, discussed in more detail further below, which may protrude outwards from the rotatable ring. The input means may function as a grip feature in that the input means may be coupled to the rotatable ring in a manner in which movement of the input means also results in rotation of the rotatable ring. As the input means may comprise a protruding element, said protruding element may be relatively easy for a user to grip and may thus function as a grip feature.

The rotatable ring may be configured to rotate around the appliance to any angular extent. In a set of embodiments, the rotatable ring is configured to rotate 360 degrees around the liquid heating appliance. Being able to rotate up to 360 degrees around the appliance may provide a maximum number of operational modes which can be selected by the rotatable ring all which facilitate accurate selection of a reduced number of operational modes. In some applications, there may be a relatively small number of operational modes which are to be selected. Accordingly, in such embodiments, it may not be necessary to be able to rotate the rotatable ring a full 360 degrees around the appliance. As such, in a set of embodiments, the rotatable ring is restricted to be capable of rotating up to 359 degrees, e.g. up to 270 degrees, e.g. up to 180 degrees, e.g. up to 135 degrees, e.g. up to 90 degrees, e.g. up to 70 degrees around the liquid heating appliance. Restriction of the angular extent to which the rotatable ring can be rotated may be achieved in any suitable manner.

Whilst the rotatable ring provides the ability to select an operational mode of the liquid heating appliance, in some embodiments, further control over the operation of the appliance may be necessary and/or desirable. In a set of embodiments, the user interface further comprises an input means configured to control of the operation of the liquid heating appliance. For example, the input means may be used to turn the appliance ON and/or OFF. The input means may also be used to control additional operational modes of the appliance. The input means may be configured to select an operational mode that is only selectable by the input means. In other embodiments, the input means is able to change the operational modes which are selectable by the rotatable ring. For example, there may be multiples sets of operational modes which are selectable by the rotatable ring, and the input means may provide a means to switch between the sets of operational modes which are selectable by the rotatable ring.

The input means may take any suitable form and be positioned in any suitable position on the appliance. In a set of embodiments, the input means is arranged to rotate with the rotatable ring. In rotating with the rotatable ring, the position of input means relative to the rest of the appliance may provide a visual indication to a user the extent to which the rotatable ring has rotated. A wall of the appliance adjacent the rotatable ring may comprise a form of marking which may be indicative of operational modes which are selectable. As such, the input means may align with the markings to indicate the operational mode selected. Rotation of the input means with the rotatable ring may thus provide a means for identifying an operational mode which is selected. In a set of embodiments, the input means extend out and/or through a part of the rotatable ring and may be coupled thereto such that it moves with the rotatable ring.

The input means may take any suitable form which allows a user to control operation of the appliance. For example, the input means may comprise a depressible button, or a plurality of such depressible buttons. However, in a set of embodiments, the input means comprises a toggle switch. The toggle switch may be configured to rest in a resting position and it may be possible to displace the toggle switch both upwards and downwards. The switch may be biased to return to the central position. Initial movement of the switch downwards may turn the appliance ON. Movement of the switch downwards, once the switch has returned to the resting position, may then turn the appliance OFF. Movement of the switch upwards may trigger a particular mode of operation, e.g. a keep warm mode of operation. The function of the input switch described above is merely exemplary and any suitable functionality may be utilised. The toggle switch may comprise a protruding element, which can be moved upwards or downwards as described above, which protrudes outwards from the appliance. In embodiments wherein the input means is arranged to rotate with the rotatable ring, the protruding element may provide the grip feature described above. In some embodiments, the input means may be in the form of a joy stick which can be moved in a plurality of different directions.

It is not essential for the input means to rotate with the rotatable ring. In other embodiments, the input means is separate to the rotatable ring and is in a fixed position on the liquid heating appliance. For example, the input means may be located above or below the rotatable ring. Arranging the input means in a fixed position on the appliance may improve the ease of use of the appliance as a user may instinctively know where the input means is, as the position of the input means does not change, irrespective of the position of the rotatable ring.

In some embodiments, the rotatable ring itself may also function as a form of input means. For example, it may be possible to depress the rotatable ring in a button-like manner. In such embodiments, the rotatable ring may be used to turn the appliance ON/OFF, or to set another operational mode of the appliance. It may be possible to depress the rotatable ring, e.g. at any position around the rotatable ring, or at a fixed number of positions around the rotatable ring. The ability for the rotatable ring to function as a button may improve the ease of use of the appliance as a user can grip the rotatable ring, rotate it to the desired position in order to select an operational mode, and the press the rotatable ring, e.g. in order to turn the appliance ON.

The detection means may comprise any suitable means for detecting the position of the rotatable ring so as to enable a determination of the operational mode selected by the rotatable ring. For example, the detection means may comprise an IR and/or an optical sensor arranged to read a set of markings. The markings may correspond to different operational modes and the detection of such markings by the IR or optical sensor may be used to set the operational mode of the appliance. The IR or optical sensor may be arranged in a fixed position and arranged to read a series of markings on the rotatable ring which move relative to the IR or optical sensor when the rotatable ring is rotated. The IR or optical sensor and the series of markings may equally be located the other way around, i.e. the IR or optical sensor being arranged to move with the rotatable ring, and the series of markings being in a fixed position on the appliance. In other examples, a Hall sensor, along with a series of magnets may be utilised. The Hall sensor and magnets may be arranged in a similar manner to the sensor and markings described above and may function in a similar manner. Whilst IR, optical and Hall sensors are described above, it will be appreciated that any other suitable form of sensor may be utilised. In a set of embodiments, the detection means comprises a rotary encoder configured to detect a position of the rotatable ring. A rotary encoder may be particularly well suited to accurately detecting an angular position of the rotatable ring. Such rotary encoders may thus be particularly well suited to embodiments wherein the rotatable ring can rotate around the appliance by 360 degrees. The detection means may comprise a plurality of rotary encoders, or indeed a plurality of any other suitable form of detection means. In some embodiments, the detection means may comprise a potentiometer. In embodiments comprising a rotary encoder, the rotary encoder may comprise a rotary potentiometer. In other embodiments, the potentiometer may comprise a linear (i.e. a slide) potentiometer. Such a linear potentiometer may be well suited for use in embodiments wherein the rotatable ring only rotates around the appliance by a limited angular extent, e.g. up to 90 degrees, e.g. up to 70 degrees. In such embodiments, a linear potentiometer may be capable of more accurately detecting the position of the rotatable ring in a relatively small number of positions.

The rotatable ring may have any suitable form around the appliance, e.g. the periphery of the appliance. In a set of embodiments, an outer surface of the rotatable ring and an outer surface of the appliance adjacent the rotatable ring are flush with one another. Having surfaces which are flush with one another may reduce the number of places on the appliance where dust and/or dirt and/or water is able to collect. This may therefore reduce the amount of cleaning of the outside of the appliance which is required. In alternative embodiments, the rotatable ring protrudes outwards further than an outer surface of a wall of the appliance which adjacent the rotatable ring. A rotatable ring which protrudes outwards in this manner may be easier to grip by a user.

It may be desirable to indicate the operational mode selected by the rotatable ring, so that a user of the appliance knows the mode in which the appliance is going to operate. In a set of embodiments, the user interface further comprises an indicator means configured to indicate the operational mode selected by the rotatable ring. The indicator means may comprise any suitable means that is capable of indicating the operational mode selected. For example, the indicator means may comprise a series of light emitting diodes (LEDs), each of which correspond to a different mode of operation. Each of the LEDs may thus illuminate depending on the mode of operation selected. In other embodiments, the indicator means comprise a display, e.g. an LED screen, which is configured to indicate the selected mode. A display may be advantageous as it may facilitate the indication of an increased number of operational modes.

The indicator means may be provided at any suitable position on the appliance such that it can be observed by a user when using the appliance. In a set of embodiments, the indicator means is arranged to rotate with the rotatable ring. In an alternative set of embodiments, the indicator means is separate to the rotatable ring and in a fixed position on the liquid heating appliance. Arranging the indicator means in this manner may advantageously mean that the indicator means is in a known place on the appliance which a user can easily refer to. It may also be easier to provide the wiring and/or electronics for an indicator means which is in a fixed position on the appliance

The indicator means may not necessarily comprise a form of electronic indication. In another set of embodiments, the indicator means comprises a series of mode markings arranged on the rotatable ring or a surface of the appliance adjacent the rotatable ring, and a mode selection marker arranged on the other of the rotatable ring or the surface adjacent the rotatable ring, and wherein the mode selection marker is arranged to align with each of the mode markings. Each of the mode markings may thus correspond to a different selected mode. In order to determine the mode selected by the rotatable ring, a user may simply observe which mode marking the mode selection marker is aligned with. Such an indicator means may be a relatively inexpensive means for indicating the selected mode. The amount of electronics required may also be reduced, thereby reducing the complexity of the appliance. This may also make manufacture and/or assembly of the appliance easier.

Rotation of the rotatable ring may be facilitated in any suitable manner. In some embodiments, at least one, e.g. a plurality, of O-ring wheel runners may be arranged to facilitate rotation of the rotatable ring. In a set of embodiments, the appliance comprises a bearing arranged to facilitate rotation of the rotatable ring. The bearing may help to ensure that the rotatable ring is able to rotate smoothly around the appliance. In a set of embodiments, the bearing comprises a thrust bearing, combined with a silicone ring which is arranged to resist movement of the rotatable ring.

The bearing may have any other suitable form. In a set of embodiments, the bearing comprises at least one ball bearing, e.g. a plurality of ball bearings, and a motion damping material arranged to dampen motion of the ball bearing(s). The motion damping material may be in the form of a coating on each of the ball bearings, or a medium, e.g. a grease, through which the ball bearings to move during use. The motion damping material may comprise a silicone coating, e.g. a silicone overmold, on at least some, e.g. all, of the ball bearings. The ball bearings themselves may facilitate rotation of the rotatable ring, whilst the motion damping material may resist rotational movement, to a certain level. Such a bearing may thus facilitate rotation of the rotatable ring whilst simultaneously preventing the rotatable ring from being rotated too easily. This may ensure that the rotatable ring can be rotated in a controlled manner thus facilitating selection of an operational mode. The ball bearings may be made from plastic, e.g. polypropylene, or any other suitable material, e.g. metal. Whilst ball bearings are described above, any other suitable form of bearings may be utilised. For example, bearings having a cylindrical shape may be used.

In a set of embodiments, the appliance comprises at least one resilient member arranged to act between the rotatable ring and an adjacent part of the appliance which the rotatable ring is arranged next to. The resilient member may be considered to be a spring member. Such a spring member may apply a resilient bias. The adjacent part of the appliance may comprise a body, or body part, of the power base or the vessel. The at least one resilient member may be arranged to apply a force to the rotatable ring so as to hold the rotatable ring in a substantially fixed vertical position relative to the adjacent part of the appliance. Accordingly, the at least one resilient member may function to prevent the rotatable ring from freely moving vertically (i.e. axially) with respect to the appliance. The resilient member may thus prevent rattling of the rotatable ring. The at least one resilient member may act to control the torque required to rotate the rotatable ring, and thus control the feel of the rotatable ring to a user. The adjacent part of the appliance may comprise any suitable part of the appliance. In some embodiments, wherein the rotatable ring is arranged on the power base, the adjacent part may comprise an upper portion or a lower portion of a main body of the power base.

The at least one resilient member may comprise a plurality of resilient members. The at least one resilient member may be a physically separate component to the rotatable ring and/or the adjacent part of the appliance. In some embodiments, however, the at least one resilient member may be integrally formed with the rotatable ring. Where a plurality of resilient members are included, each of the of resilient members may act at a different angular position around the rotatable ring, i.e. they may be angularly displaced around the rotatable ring. In other embodiments, the at least one resilient member may be integrally formed with the adjacent part of the appliance. The at least one resilient member may be in the form of a leaf spring. It may be possible to form such a leaf spring integrally with the rotatable ring, without necessarily significantly increasing the volume of material required or the complexity of manufacture. In other embodiments, the at least one resilient member may be in the form of a helical spring or a resiliently deformable block of material.

The liquid heating appliance may comprise a controller which is coupled to the detection means. The controller may be configured to implement the operational mode detected by the detection means. The detection means may output an operational mode to the controller, which the controller may implement. In other embodiments, the controller may interpret a signal from the detection means, and determine the operational mode from this signal. This may, for example, comprise interrogating a look-up-table, to determine the operational mode selected. In embodiments comprising an indicator means which is in electronic form, e.g. comprising LEDs or a display, the controller may also control operation of the indicator means depending on the operational mode selected. The controller may also be operationally coupled to the input means, where provided.

In a set of embodiments, the liquid vessel comprises a heating arrangement for heating a liquid contained within the liquid vessel. The liquid vessel may comprise a liquid chamber which contains a liquid to be heated. The heating arrangement may take any suitable form. In a set of embodiments, the heating arrangement comprises an underfloor heating arrangement. The heating arrangement may comprise a sheathed electrical heating element.

The liquid vessel is separable from the power base and thus the liquid heating appliance may be considered to be a cordless liquid heating appliance. In being arranged on the power base, the liquid vessel may be considered to be removably arranged thereon. The liquid heating appliance may be a kettle. In rotating around the liquid heating appliance, the rotatable ring may rotate around an axis of the appliance. The axis of the appliance may extend through a centre of the power base and/or a centre of the liquid vessel. The axis of the appliance may extend substantially vertically, e.g. vertically, when the appliance is arranged on a work surface.

The power base may comprise a power cable (e.g. a power supply cable) extending therefrom configured to be connected to a suitable power supply. In embodiments wherein the rotatable ring is arranged on the power base, the power cable may be arranged to extend from (i.e. out of) the power base at a position above the rotatable ring. This is in contrast to the arrangement of the power cable in typical power bases whereby the power cable extends from a position as low as possible on the power base. Arranging the power cable to extend from the power base at a position above the rotatable ring may reduce the overall height of the power base, as the power cable may extend into a body or housing of the power base which is above the rotatable ring and which may not be omitted nor reduced in height, whereas the body or housing of the power base below the rotatable ring may be omitted or reduced in height.

In any of the embodiments described above, the power base may comprise a cordless electrical connector and the liquid vessel may comprise a cordless electrical adapter, wherein the cordless electrical adapter is configured to mate with the cordless electrical connector when the liquid vessel is arranged (e.g. seated) on the power base. The cordless electrical connector and adapter may provide an electrical connection between the power base and liquid vessel, and allow the transmission of electrical power and/or data therebetween. In some embodiments, the cordless electrical connector and the cordless electrical adapter may be configured to allow the liquid vessel to be seated on the power base at any angular orientation thereto.

The Applicant has recognised that a user interface comprising a rotatable ring is not only advantageous on appliances in which a liquid vessel is arranged on a power base, but also on liquid vessels which are not arranged on a power base, e.g. corded liquid heating appliances, or indeed any other such liquid heating appliance which is not arranged on a power base.

Therefore, according to a second aspect of the present invention there is provided a liquid heating appliance comprising: a liquid vessel; a user interface, for setting an operational mode of the liquid heating appliance; comprising: a rotatable ring which extends 360 degrees around the liquid heating appliance; and a detection means configured to detect the position of the rotatable ring; wherein the position of the rotatable ring determines the operational mode of the liquid heating appliance.

Any of the features of the embodiments described above, except those relating to the power base, may equally be applied to the second aspect of the invention. The liquid heating appliance of this second aspect of the present invention may be devoid of a power base and instead the liquid vessel may be connected directly to a power supply, e.g. a corded power supply. As such, the liquid heating appliance according to this second aspect of the invention, in some embodiments, may be considered to be a corded liquid heating appliance.

Whilst the various embodiments described above, according to either aspect of the invention, are directed to a liquid heating appliance comprising a rotatable ring which extends 360 degrees around the appliance, the Applicant has appreciated that it may nonetheless be possible to achieve some of the advantages of the invention when the rotatable ring extends substantially around the appliance, but not entirely around, i.e. not a full 360 degrees around the appliance. Accordingly, in alternative embodiments, the rotatable ring may instead extend at least 270 degrees, e.g. at least 300 degrees, e.g. at least 330 degrees around the appliance, whilst potentially still achieving some of the advantages of the embodiments set out above.

### BRIEF DESCRIPTION OF THE DRAWINGS

Some preferred embodiments of the present invention will now be described, by way of example only, and with reference to the accompanying drawings, in which:

FIG. 1 is a perspective view of a liquid heating appliance in accordance with an embodiment of the present invention, when viewed from a first side;

FIG. 2 is a perspective view of the liquid heating appliance shown in FIG. 1 when viewed from the opposite side;

FIG. 3 is a cross-sectional view through the liquid heating appliance;

FIG. 4 is a perspective view of the liquid vessel and the power base, of the liquid heating appliance, separated from one another;

FIG. 5 is a cut-away view through the appliance revealing the detector of the user interface;

FIG. 6 is a perspective view of the rotatable ring, with various components of the appliance hidden;

FIG. 7 is a perspective view of the rotatable ring in isolation;

FIG. 8 is a perspective view of a liquid heating appliance in accordance with another embodiment of the present invention, whereby the user interface is located at a lower end of the liquid vessel;

FIG. 9 is a perspective view of the liquid heating appliance shown in FIG. 8, when viewed from the other side;

FIG. 10 is a perspective view of the liquid heating appliance shown in FIG. 8, with the liquid vessel separated from the power base;

FIG. 11 is a perspective view of a liquid heating appliance in accordance with a further embodiment of the present invention, whereby the user interface is located at an upper end of the liquid vessel;

FIG. 12 is a perspective view of the liquid heating appliance in FIG. 11, when viewed from the other side;

FIG. 13 is a cut-away view focusing on the powerbase of a liquid heating appliance in accordance with another embodiment of the invention, showing a bearing arranged therein;

FIG. 14 is a sectional view focusing on the bearing shown in FIG. 13;

FIG. 15 is a perspective view of a liquid heating appliance in accordance with a further embodiment of the present invention;

FIG. 16 is a side-on view of part of a power base of a liquid heating appliance in accordance with an embodiment of the present invention;

FIG. 17 is a perspective view of a power base of a liquid heating appliance in accordance with another embodiment of the present invention;

FIG. 18 is an exploded view of the power base shown in FIG. 17;

FIG. 19 is a perspective view of a power base of a liquid heating appliance in accordance with an embodiment of the present invention, whereby the rotatable ring is arranged to rotate 360 degrees;

FIG. 20 is a perspective view of the power base shown in FIG. 19 with the upper portion hidden so as to reveal the internal components thereof; and

FIG. 21 is a cross-sectional view through the power base shown in FIG. 20.

### DETAILED DESCRIPTION

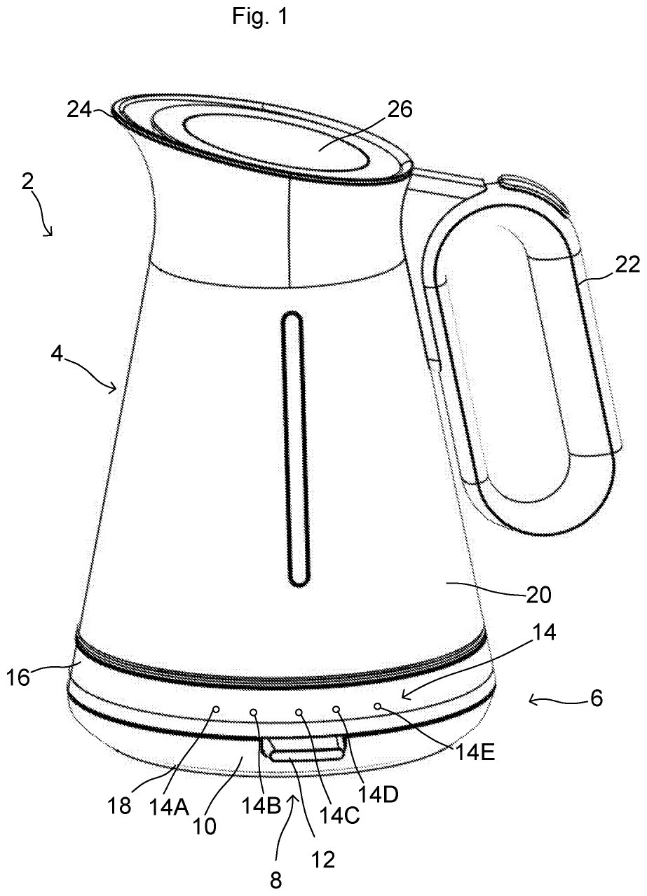

FIG. 1 shows a perspective view of a liquid heating appliance 2 (hereinafter “appliance 2”), in accordance with an embodiment of the present invention, when viewed from a first side. The appliance 2 comprises a liquid heating vessel 4 and a power base 6. Whilst not depicted, the power base 6 is connected to a power source, e.g. a plug socket. This may be achieved using a power cable (not shown).

The appliance 2 comprises a user interface 8 for setting an operational mode of the appliance 2. The user interface 8 comprises a rotatable ring 10 which extends 360 degrees around the appliance 2. An input means 12, in the form of a toggle switch, is also provided with the rotatable ring 10. Whilst a toggle switch is depicted, the input means 12 may take any other suitable form. In this embodiment, the input means 12 moves with the rotatable ring 10. As such, the input means 12 may be used to drive rotation of the rotatable ring 10. However, the input means 12 may alternatively be arranged on any other part of the appliance 2.

In the embodiment depicted in FIG. 1, the user interface 8 is located on the power base 6. However, as will be apparent with reference to later Figures, the user interface 8 may instead be located on the liquid vessel 4. Equally, the user interface 8 may be divided between the liquid vessel 4 and the power base 6.

In some embodiments, as depicted, the user interface also comprises an indicator means 14. The indicator means 14 may indicate an operational mode of the appliance 2. For example, the indicator means 14 may indicate the temperature mode of operation of the appliance, i.e. the temperature to which the appliance is configured to heat the contents of the liquid vessel, or indeed any other suitable mode of operation. The indicator means 14 may take any suitable form that is capable of informing a user of the operational mode. In an embodiment, the indicator means 14 comprises a series of indicators 14A, 14B, 14C, 14D, 14E. Each of the indicators 14A-14E, may correspond to a different temperature mode, or other suitable mode, and may be configured to illuminate when a specific mode is selected. In other embodiments, the indicator means 14 may comprise a display, e.g. an LED display.

The power base 6 comprises a main body which comprises an upper portion 16 which is arranged above the rotatable ring 10. The upper portion 16 is arranged between the rotatable ring 10 and a main body 20 of the liquid vessel 4. As such, when the liquid vessel 4 is arranged on the power base 6, as shown in FIG. 1, the main body 20 of the liquid vessel rests against the upper portion 16 of the power base 6, rather than resting directly against the rotatable ring 10. This ensures that the rotatable ring 10 is not inhibited from rotating when the liquid vessel 4 is arranged on the power base 6.

Similarly, in some embodiments, as depicted, a lower portion 18 of a main body of the power base 6 is arranged beneath the rotatable ring 10, and is arranged to rest on a work surface. The lower portion 18 may thereby position the rotatable ring 10 a distance away from the work surface so that it can be easily accessed by a user. Also, similarly to the upper portion 16, the lower portion 18 may hold the rotatable ring 10 away from the work surface so it is not inhibited from rotation, during use thereof.

The liquid vessel 4 may comprise a handle 22 for lifting the liquid vessel 4 away from the power base 6, and for pouring the contents therefrom. In this regard, the liquid vessel 4 may comprise a spout 24, through which liquid may be poured out of the liquid vessel 4, as well as an openable lid 26 through which the liquid vessel 4 may be filled.

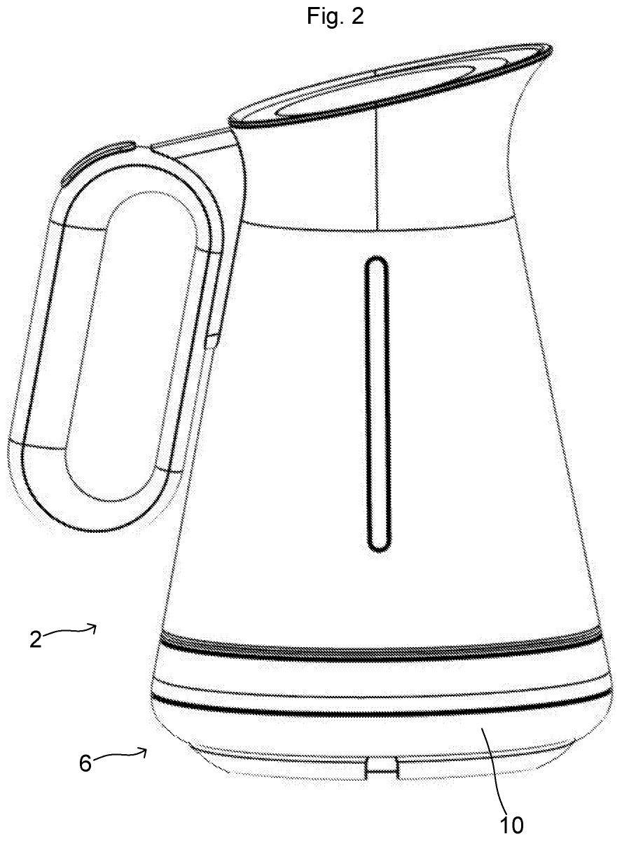

FIG. 2 shows a perspective view of the appliance 2 when viewed from the opposite side of the appliance 2 to that shown in FIG. 1. It is evident from FIG. 2 that the rotatable ring 10 extends a full 360 degrees around the power base 6.

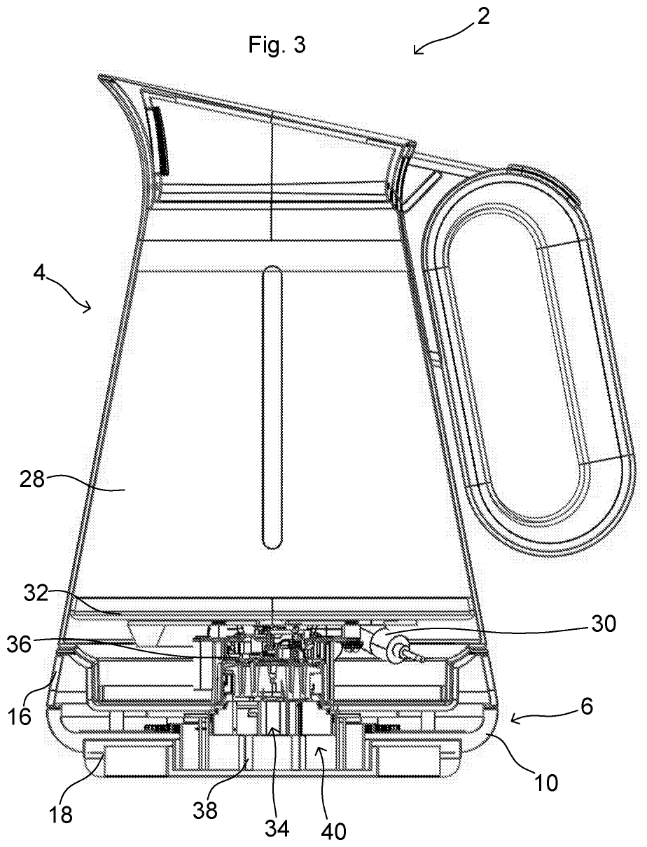

FIG. 3 shows a cross-sectional view through the appliance 2. As evident in this Figure, the liquid vessel 4 comprises a liquid chamber 28 which may be filled with liquid during use. The liquid vessel 4 may further comprise a heating arrangement 30 for heating the liquid contained within the liquid chamber 28. In the embodiment depicted, the heating arrangement 30 is in the form of an underfloor heating arrangement, i.e. located below a base wall 32 of the liquid chamber 28. In the embodiment depicted, the heating arrangement 30 comprises a sheathed electrical heating element. However, whilst this specific form of heating arrangement 30 is depicted, it will be appreciated that any other suitable form of heating arrangement 30 may be provided to heat the contents of the liquid chamber 28.

As shown in FIG. 3, the power base 6 may comprise an electrical connector 34 which mates with a corresponding electrical adapter 36 provided at the base of the liquid vessel 4. The mating of the electrical connector and adapter set 36, 38 facilitates the transfer of electrical power to the heating arrangement 30 provided in the liquid vessel 4. The electrical connector and adapter set 36, 38 may be of the 360-degree type which facilitate placement of the liquid vessel at any angular orientation on the power base 6. However, it will be appreciated that any other suitable means of transferring power from the power base to the liquid vessel 4 may be utilized.

As depicted in FIG. 3, the lower portion 18 of the power base 6, is coupled to the upper part 16 of the power base 6, by an upstanding portion 38 which couples to the electrical connector 34 which is in turn coupled to the upper part 16. The rotatable ring 10 is then sandwiched between the upper and lower parts 16, 18. The upstanding portion 38 extends through an aperture 40 in the rotatable ring 10.

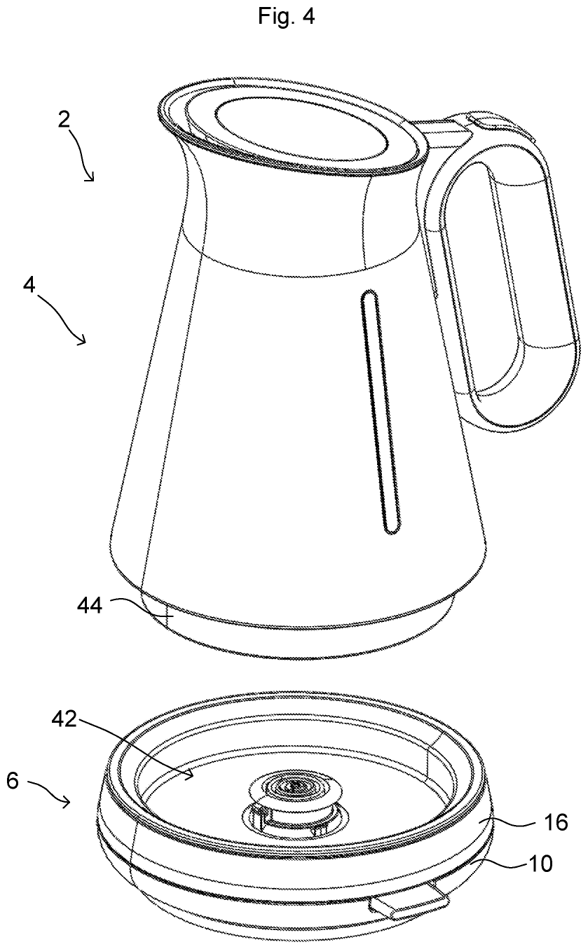

FIG. 4 shows a perspective view of the appliance 2, with the liquid vessel 4 separated from the power base 6. As depicted, the upper portion 16 of the power base, together with the rotatable ring 10, may define a recess 42 in the power base 6. The recess 42 is shaped to receive a correspondingly shaped base 44 on the liquid vessel. The recess 42 may help to more easily locate the liquid vessel 4 on the power base 6 during placement thereof.

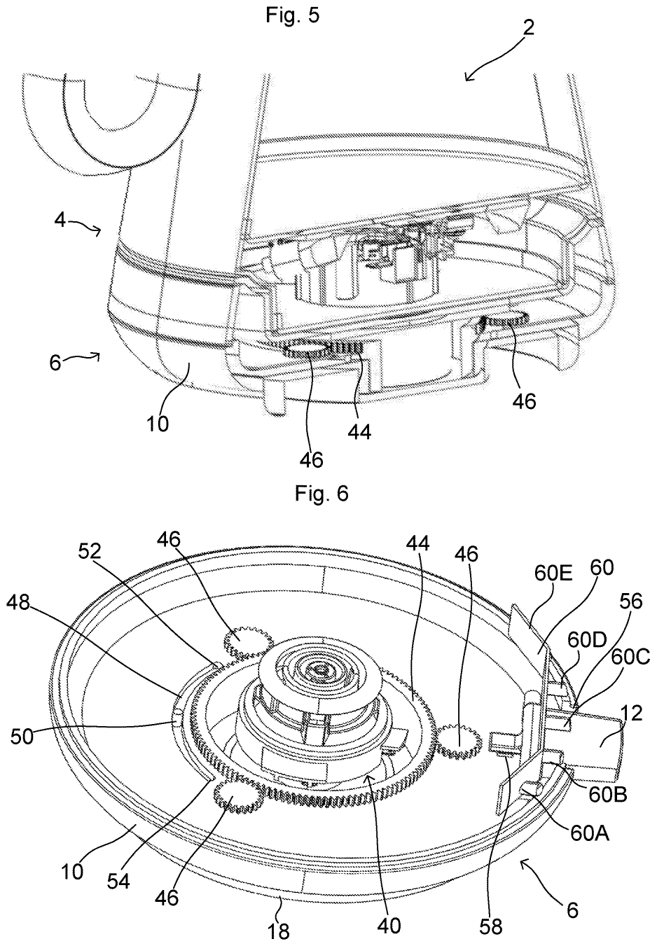

FIG. 5 shows a cut-away view through the appliance 2 focusing on a lower portion thereof where the liquid vessel 4 rests on the power base 6. As visible in this cut-away view, the appliance 2 comprises a detection means 46 configured to detect a rotational position of the rotatable ring 10. In some embodiments, as depicted, the appliance 2 may comprise a plurality of detection means 46, specifically three detection means, however any number of detection means 46 may be provided and indeed a single detection means 46 may be sufficient. Having a plurality of detection means 46 may nonetheless increase the accuracy of detection of the position of the rotatable ring 10. A plurality of detection means may also help towards achieving a consistent feedback through the rotatable ring 10 to a user, irrespective of the location at which a user applies a force to the rotatable ring 10. In the embodiment depicted, the detection means 46 are in the form of rotary encoders 46 which engage with teeth 44 arranged on the rotatable ring 10. Each rotary encoder 46 may comprise a rotary potentiometer. As the rotatable ring 10 is rotated, the teeth 44 rotate around an axis of the appliance 2 and drive rotation of the detection means 46. This rotation is converted into an electrical signal in order to set the operational mode of the appliance 2. Whilst the plurality of teeth 44 are arranged at a center of the rotatable ring 10, they may be arranged at any suitable position whereby they are capable of interacting with the detection means 46.

FIG. 6 shows a cut-away view of the appliance 2 showing the rotatable ring 10, arranged on the lower part 18, but with a number of the components above the rotatable ring 10 hidden so that the features of the rotatable ring 10 can be seen more clearly. As shown in this Figure, the rotatable ring 10 may comprise an arc-shaped slot 48. A protrusion 50, extending from the lower portion 18 of the power base 6 may extend into the slot 48. As will be appreciated by those skilled in the art, the angular extent to which the rotatable ring 10 is able to rotate will be restricted by the slot 48 and associated protrusion. As the rotatable ring 10 is rotated, with the protrusion 50 remaining in a fixed position, the protrusion 50 will eventually contact a first end 52 of the slot 48 or a second end 54 of the slot 48. When the protrusion 50 contacts either of the first end 52 or the second end 54, further rotation of the rotatable ring 10 will be prevented. As will be appreciated by those skilled in the art, the amount of permitted rotation of the rotatable ring 10 may thus be determined by the angular extent of the slot 48, and/or the shape and extent of the protrusion 50. In the embodiment depicted, the slot 48 extends approximately 90 degrees around an axis of the appliance 2. As a result, the rotatable ring 10 will be able to rotate up to approximately 90 degrees around the appliance 2. In other embodiments, the slot 48 may have a greater extent, e.g. by extending up to 180 degrees or more, such that the rotatable ring 10 can rotate more than 90 degrees. In other embodiments, the rotatable ring 10 may be free to rotate 360 degrees around the appliance 2. In such embodiments, the slot 48 and protrusion 50 may be omitted.

FIG. 6 also more clearly shows the teeth 44 of the rotatable ring 10. As shown, the teeth 44 extend around the entire aperture 40 in the rotatable ring 10. In other embodiments, the teeth 44 may only extend around part of the aperture 40. The teeth 44 may be arranged in any other suitable position. The number of teeth 44, and their form, as well as their interaction with the detection means 46, may define the number of modes which can be selected using the rotatable ring 10. For example, the more teeth 44 which are present may facilitate selection of an increased number of operational modes of the appliance 2.

As shown in FIG. 6, three separate detection means 46 are included in the embodiment. However, it will be appreciated that any number of detection means 46 may be utilized.

The input means 12 extends through an opening 56 in a side of the rotatable ring 10. The input means 12 is in the form of a toggle switch which can be titled up and down depending on the intended input. A first tactile switch 58 is arranged to detect when the input means 12 is tilted upwards, and a second tactile switch (not visible in this Figure) is arranged to detect when the input means 12 is tilted downwards. The input means 12 is provided with the rotatable ring 10 and moves with the rotatable ring 10 when it is rotated. In other embodiments, the input means 12 may be separate to the rotatable ring 10 and remain in a fixed position on the appliance 2 when the rotatable ring 10 is rotated.

Also visible in FIG. 6 is the circuit board 60 of the indicator means 14. The circuit board 60 comprises light emitting diodes (LEDs) 60A-60E that are integrated therewith and arranged to illuminate the indicators 14A-14E shown in FIG. 1.

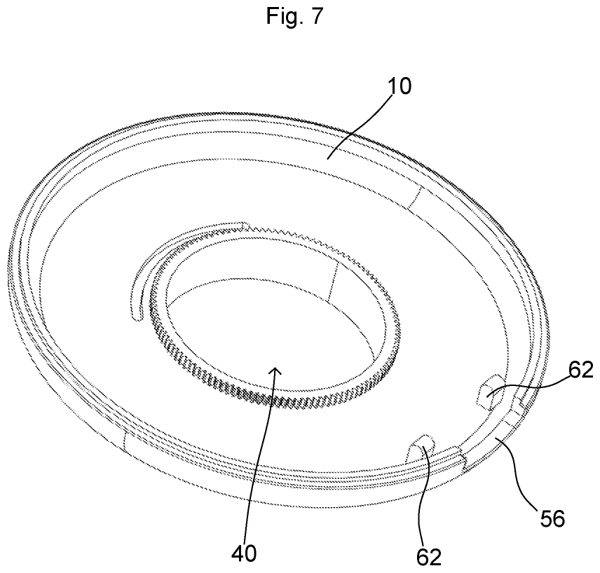

FIG. 7 shows a perspective view of the rotatable ring 10 in isolation from the other components of the appliance 2. This Figure more clearly shows the aperture 40 at the center of the rotatable ring 10. The opening 56, through which the input means 12 extends, can also more clearly be seen. The rotatable ring 10 comprises mounting points 62, to which the input means 12 may be mounted. The mounting points 62 may facilitate pivotal mounting of the input means 12 such that it can be pivoted relative to the rotatable ring 10. The mounting points 62 may be integrally provided with the rotatable ring 10. Whilst two mounting points 62 are shown in the embodiment depicted, it will be appreciated that any number of mounting points 62 may be present depending on the particular form of the input means 12. The form of the mounting point(s) 62 may also depend on the form of the input means 12 and how it needs to be mounted.

Operation of the appliance 102 will now be described with reference to FIGS. 1 to 7. A user may initially fill the liquid vessel 4. This may be achieved by separating the liquid vessel 4 from the power base 6, opening the openable lid 26, and filling the liquid vessel 4, specifically the liquid chamber 28 thereof. Once filled with the desired amount of liquid, a user may then replace the liquid vessel 4 on the power base 6 ready for heating.

Once the liquid vessel 4 is seated on the power base 6, a user may then select their desired mode of operation. This may involve a user rotating the rotatable ring 10 to a position which corresponds to their desired mode. As a user rotates the rotatable ring 10, the position of the rotatable ring 10 is determined by the detection means 46. In the embodiment depicted in FIGS. 1-7, as the rotatable ring 10 is rotated around an axis extending through the appliance 2, the teeth 44 on the rotatable ring engage with the detection means 46 which are in the form of rotary encoders. The detection means 46 thus function to detect movement of the rotatable ring 10. The detection means 46 are connected to suitable control circuitry, or indeed a controller, and one of the indicators 14A-14E is illuminated by a respective one of the LEDs 60A-60E, based on the position of the rotatable ring 10.

A user may thus be able to determine the mode selected by the rotatable ring 10 by monitoring the illumination of the indicators 14A-14E. Once the indicator 14A-14E which corresponds to the desired mode of operation is illuminated, a user may then stop rotating the rotatable ring 10. As the rotatable ring 10 extends around the entire appliance 2, a user may drive rotation of the rotatable ring 10 at any position around the appliance. This may improve the ease of use of the appliance.

A position whereby the protrusion 50 abuts against a second end 54 of the slot 48 in the rotatable ring 10, may correspond to a position whereby the mode associated with indicator 14E is selected, and a position whereby the protrusion 50 abuts against the first end 52 of the slot 48 may correspond to a position whereby the mode associated with indicator 14A is selected. Positions in between these two extremes may correspond to selection of the modes associated with indicators 14B-14D.

Following selection of the desired mode, a user may then operate the input means 12, e.g. by pressing down on the input means 12, to turn the appliance ON and begin the heating process. When the input means 12 is operated, this may cause a controller to cause the heating means 30 to be supplied with power so as to heat the contents of the liquid vessel 4. Further operation of the input means 12, e.g. by pressing down on the input means 12 again, may stop the supply of power to the heating means 30 and thus prevent further heating, i.e. it may turn OFF the appliance 2. This may therefore be used as a means to interrupt heating of the contents of the liquid vessel 4, e.g. if a user decides they no longer require heated liquid. The input means 12 may also be lifted upwards. Lifting upwards of the input means may trigger a different operational mode of the appliance 2. For example, lifting the input means 12 upwards may cause the appliance 2 to operate in a keep warm mode, whereby following heating, the appliance 2 operates to maintain the temperature of the liquid therein within a predefined range. Movement of the input means 12 may be detected by the tactile switch 58, or indeed any other suitable means for detecting movement of the input means 12.

Whilst in some embodiments it may be necessary to operate the input means 12 in order to trigger heating to occur, in other embodiments this may not be necessary. For example, following movement of the rotatable ring 10 to a desired position, the appliance 2 may be suitably configured that the appliance then proceeds to begin heating of the liquid within the liquid vessel 4 without requiring further input from a user.

Whilst selection of a mode is discussed above, if, following placement of the liquid vessel 4 on the power base 6 an indicator 14A-14E is already illuminated and this corresponds to the desired mode of operation, a user may not then need to rotate the rotatable ring 10. Instead, they may simply operate the input means 12 to trigger heating of liquid within the liquid vessel 4.

In any of the embodiments described above, the appliance 2 may comprise a suitable controller configured to operate the appliance 2 in the desired mode of operation. Such a controller may for example, receive data from a temperature sensor which is arranged to monitor the temperature of liquid within the liquid vessel 4. The controller may then operate the heating means 30 accordingly depending on the measured temperature.

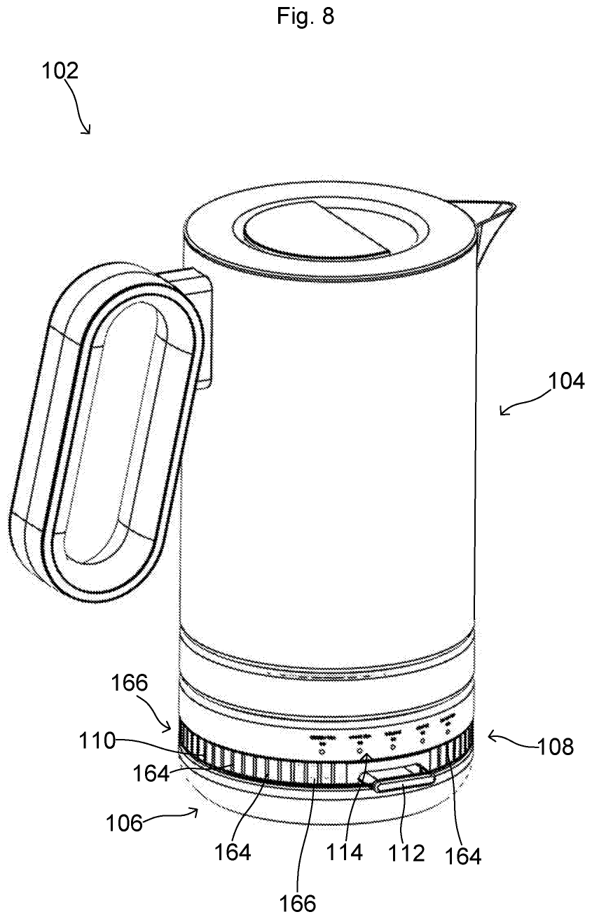

FIG. 8 shows a perspective view of a liquid heating appliance 102 (hereinafter “appliance 102”) in accordance with another embodiment of the present invention, whereby the user interface 108, specifically the rotatable ring 110 thereof, is provided on the liquid vessel 104, rather than on the power base 106. Similarly to the previous embodiment, an input means 112 is arranged to move with the rotatable ring 110, and an indicator means 114 is also provided to indicate the operational mode selected. The user interface 108 is substantially the same as the user interface 8 described above and thus functions in a corresponding manner. In addition to the input means 112 which may function as a grip feature for rotating the rotatable ring 110 around the appliance 102, the rotatable ring 110 also comprises a series of axially extending ridges 164 around its outer surface 166. As will be appreciated by those skilled in the art, the axially extending ridges may make it easier for a user to grip and rotate the rotatable ring 110, and may thus also be considered to be a form of grip feature. In the embodiment shown in FIG. 8, the user interface 108, or at least the rotatable ring 110 thereof, is arranged at a lower end 166 of the liquid vessel 104.

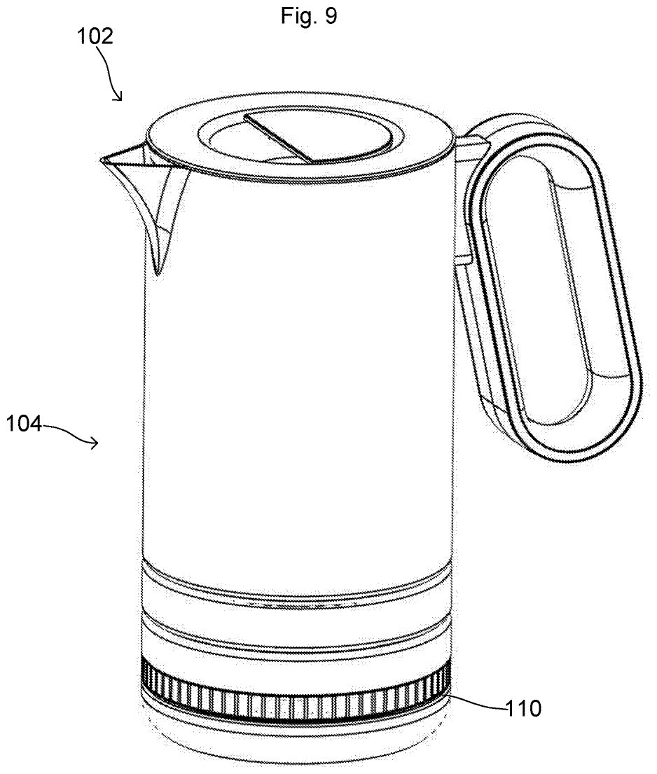

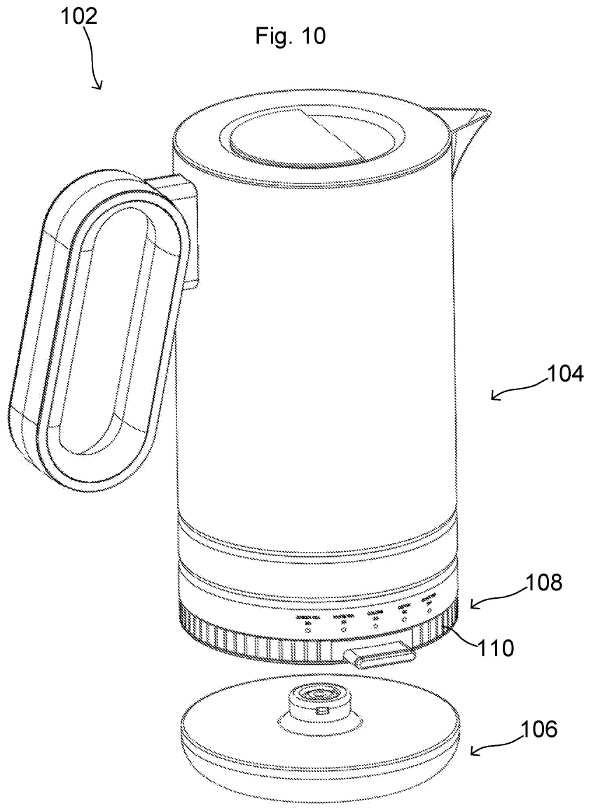

FIG. 9 is a perspective view of the appliance 102 when viewed from the other side and clearly demonstrates how the rotatable ring 110 extends a full 360 degrees around the appliance 102, specifically around the liquid vessel 104. FIG. 10 is a perspective view of the appliance 102 shown in FIGS. 8 and 9 with the liquid vessel 104 separated from the power base 106, and clearly shows how the user interface 108, specifically the rotatable ring 110 thereof, is arranged on the liquid vessel 104 and thus moves therewith.

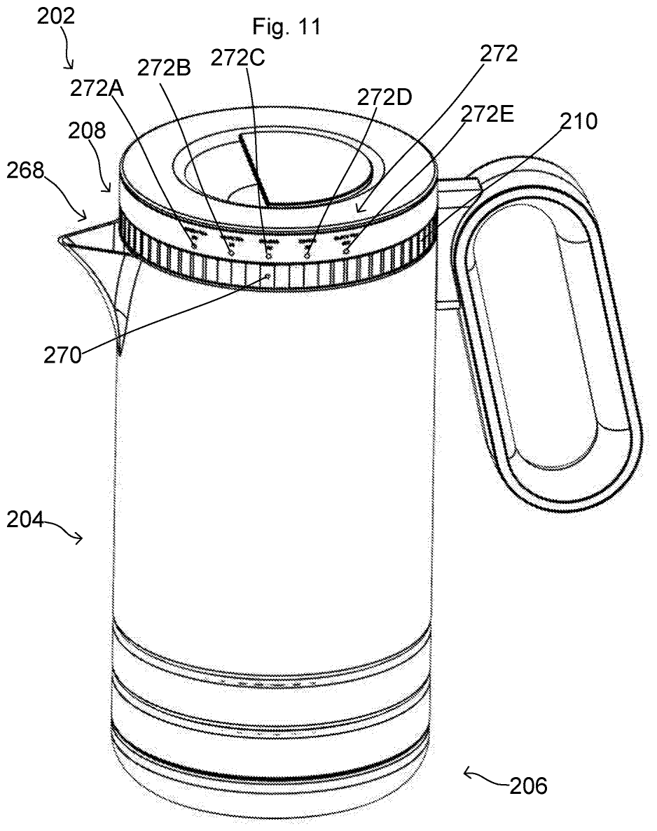

FIG. 11 shows a perspective view of a liquid heating appliance 202 (hereinafter “appliance 202”) in accordance with another aspect of the present invention. In this embodiment, the user interface 208 is arranged on the liquid vessel 204. Specifically, the user interface 208 is arranged at an upper end 268 of the liquid vessel 204. The user interface 208 is largely the same as the user interface 108 described above, except that it does not include an input means in the form of a toggle switch. In this embodiment, the user interface 208 comprises an indicator means which comprises a mode marking 272 which comprises a series of separate mode markings 272A-272E. An indicator marking 270 is arranged on the rotatable ring 210, and is arranged to align with each of the mode markings 272A-272E of the mode marking 272. Accordingly, in order to select a mode of operation, the rotatable ring 210 may be rotated such that the indicator marking 270 aligns with a respective one of the mode markings 272A-272E. Alignment of the indicator marking 270 with one of the mode markings 272A-272E indicates selection of the mode corresponding to the marking 272A-272E. Each of the mode markings 272A-272E may correspond to a different temperature to which the liquid is heated, or a different operation of the appliance 202. Text or images may be arranged next to the mode markings 272A-272E which provide context as to the mode selected. For example, the temperature of each mode may be arranged adjacent each of the mode markings 272A-272E. This may also be the case for the indicators 14A-14E described above.

FIG. 12 shows a perspective view of the appliance 202 when viewed from the other side and clearly shows how the rotatable ring 210 of the user interface 108 extends 360 degrees around the appliance 202, specifically the liquid vessel 204 thereof.

Whilst in the embodiments described above, the user interface, specifically the rotatable ring thereof, has been shown on the power base, on the lower end of the liquid vessel, and on the upper end of the liquid vessel, it will be appreciated that the user interface, e.g. the rotatable ring, may be located at any other suitable position on the appliance. For example, the rotatable ring may be located at an intermediate position on the liquid vessel, at a position between the upper and lower ends thereof.

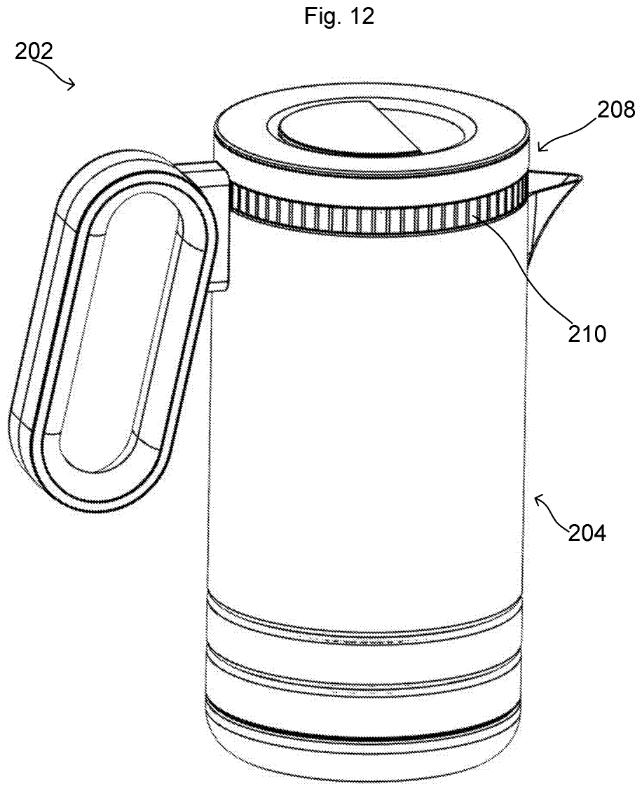

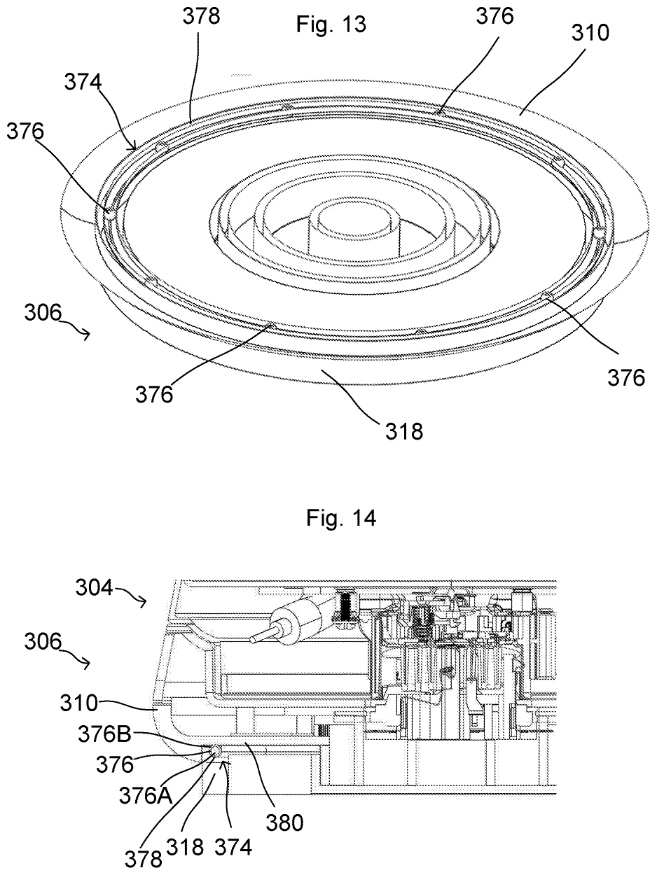

FIG. 13 shows a cut-away view of a power base 306 of a liquid heating appliance of another embodiment of the present invention. In this embodiment, a bearing 374 is arranged to facilitate rotation of the rotatable ring 310 (which is shown partially cut-away in this view). The bearing 374 comprises a plurality of ball bearings 376 which are arranged to move in a track 378. In the embodiment depicted, the track 378 is formed as a generally U-shaped channel in the lower portion 18 of a main body of the power base 306. The rest of the appliance in this embodiment may be identical to the appliance shown in FIG. 1.

FIG. 14 shows a cross-sectional view through the appliance focusing on the bearing 374 shown in FIG. 13. In this Figure, the liquid vessel 304 is shown on top of the power base 306. As visible in this Figure, a lower surface 380 of the rotatable ring 310 rests on the ball bearings 376 of the bearing 374. As the rotatable ring 310 is rotated, the ball bearings 376 rotate in the track 378 and thereby facilitate rotation of the rotatable ring 310. In some embodiments, as depicted, the ball bearings 376 may each comprise a ball 376A together with a motion damping material 376B, which is in the form of a coating, e.g. an overmolding, on at least some of the balls 376A. The motion damping material 376B may comprise silicone. Such ball bearings 376 may facilitate controlled rotation of the rotatable ring 310, as the motion damping material 376B may partially resist rotational movement of the balls 376A, and thus the rotatable ring 310, thereby ensuring it can be rotated in a controlled manner. In other embodiments, the ball 376B may be coated with any material, other than silicone, but which nonetheless provides a similar effect of partially increasing the resistance to motion experienced by the ball 376A. Similarly, the track 378 may be at least partially filled with a motion damping material, e.g. grease, so as to dampen movement of the ball bearings 376. Whilst a particular form of bearing is described and depicted, it will be appreciated that any suitable bearing, arranged in any suitable manner, may be used to facilitate rotation of the rotatable ring. The bearing 374 described above may be utilized in any of the embodiments described herein.

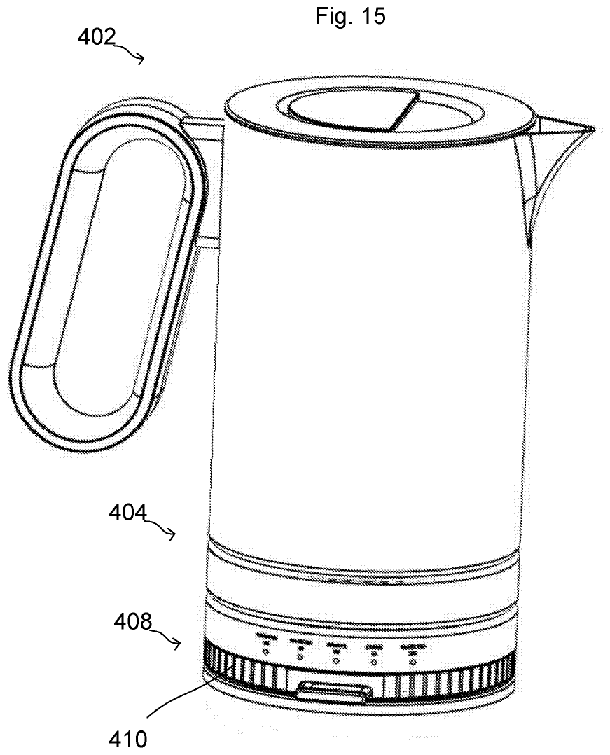

FIG. 15 shows a perspective view of a liquid heating appliance 402 in accordance with another embodiment of the present invention. In this embodiment, the user interface 408, specifically the rotatable ring 410 thereof, is arranged on the liquid vessel 404. In this embodiment, the liquid heating appliance 402 does not comprise a power base and instead the liquid vessel may be supplied with power directly from a power cord (not shown). This liquid heating appliance 402 may thus be considered to be a corded liquid heating appliance.

The user interface 408 may be identical to the user interface 108 described above in respect of FIG. 8.

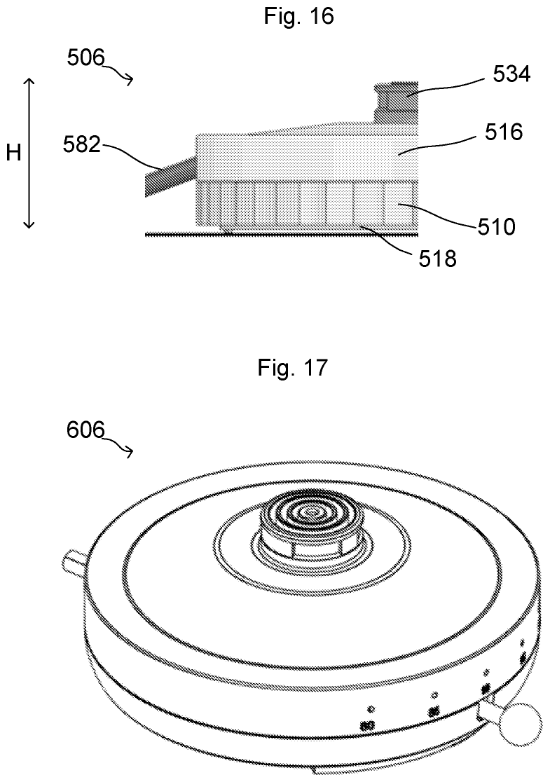

FIG. 16 shows a partial view of a power base 506 of an appliance according to another embodiment of the present invention. The power base 506 may receive a liquid vessel 4, of the type described above, thereon. In the embodiment shown in FIG. 16, the power base 506 comprises a rotatable ring 510, an upper portion 516, a lower portion 518 an electrical connector 534 and a power cable 582 (i.e. a power supply cable 582). In some embodiments, as depicted, the power cable 582 (i.e. a power supply cable 582) extends from the power base 506 (e.g. out of a main body thereof) at a position above the rotatable ring 510. This may reduce the overall height, H, of the power base 506 as the depth of the lower portion 518 may be reduced. For example, the power supply cable 582 may extend out of the upper portion 516.

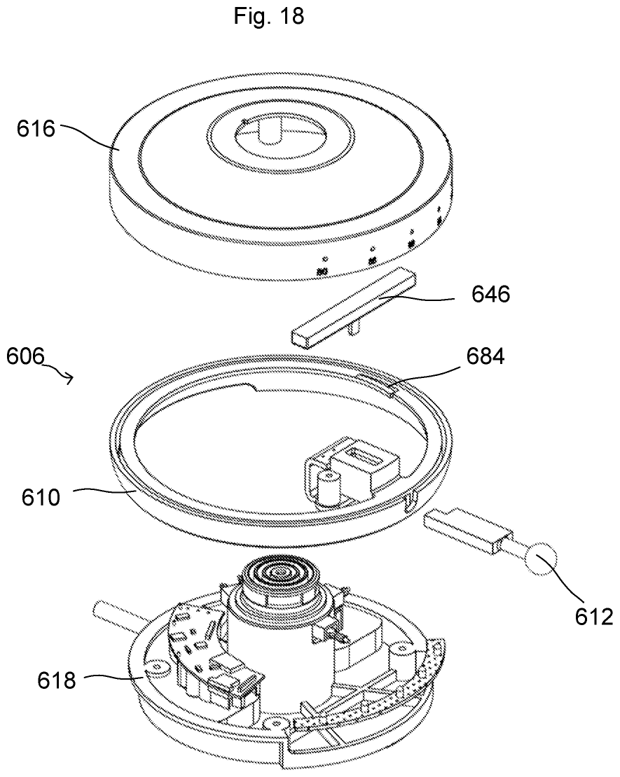

FIG. 17 shows a perspective view of a power base 606 of an appliance according to another embodiment of the present invention. The power base 606 may receive a liquid vessel 4, of the type described above, thereon. An exploded view of the power base 606 is shown in FIG. 18. With continued reference to FIG. 18, similarly to other embodiments, the power base 606 comprises a main body defined by an upper portion 616 and a lower portion 618. A rotatable ring 610 (of a user interface) is arranged therebetween. An input means 612 is provided and coupled to the rotatable ring 610, so as to move therewith and be capable of driving rotation thereof. In this embodiment, the rotatable ring 610 is constrained to rotate up to approximately 70 degrees around the power base 606. Of course, it will be appreciated, that the rotatable ring 610 may be constrained to rotate by any other suitable amount, and indeed in some embodiments may be free to rotate around 360 degrees.

In some embodiments, as depicted in FIG. 18, the power base 606 may comprise a detection means 646 in the form of a linear (i.e. a slide) potentiometer 646. Such a linear potentiometer may be particularly well suited to determining the rotational position of the rotatable ring 610 in embodiments wherein the rotatable ring 610 is constrained to only move a limited angular extent relative to the other parts of the power base 606.

In addition, as depicted in FIG. 18, in some embodiments, the appliance may comprise a resilient (e.g. spring) member 684. The resilient member 684 may be arranged to act between the rotatable ring 610 and an adjacent part of the appliance which the rotatable ring 610 is (e.g. vertically) adjacent to. In the embodiment depicted, the adjacent part of the appliance is the lower portion 618 of the main body of the power base 606. In some embodiments, as depicted, the resilient member 684 may be integrally formed with the rotatable ring 610. The resilient member 684 may be in the form of a leaf spring, as shown. Of course, the resilient member 684 may have any other suitable form and may be independent of the rotatable ring 610 (i.e. a separate component). Whilst only a single resilient member 684 is shown, it will be appreciated that a plurality of resilient members 684 may be included. As will be appreciated by those skilled in the art, when the power base 606 is assembled, the resilient member 684 applies a biasing force pushing the rotatable ring 610 in an upward direction. This biasing force provided by the resilient member 684 may help to prevent the rotatable ring 610 from rattling within the appliance. Additionally, or alternatively, the resilient member 684 may, at least partially, set the force, i.e. the torque, required to rotate the rotatable ring 610.

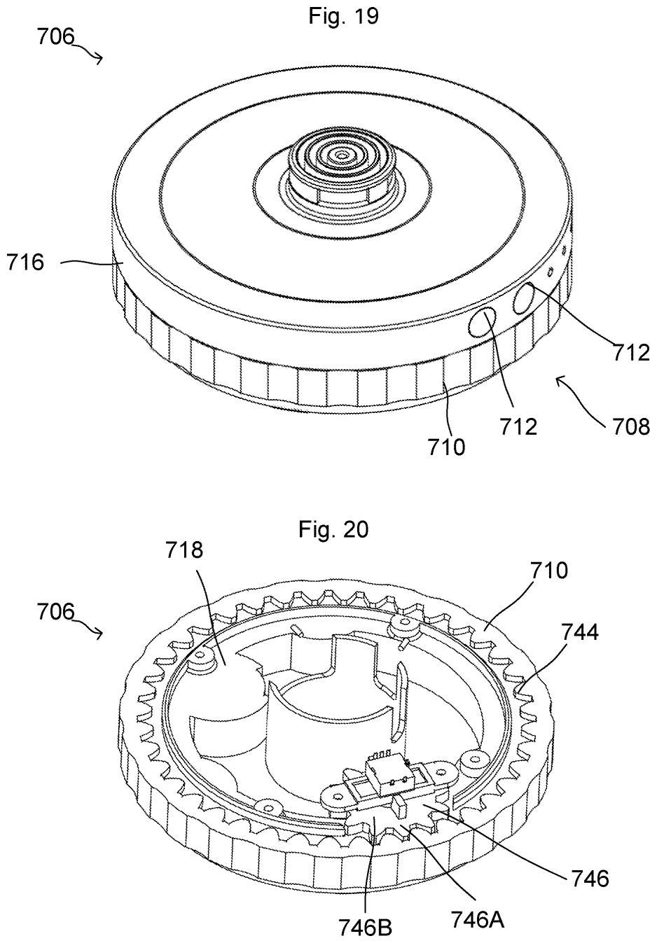

FIG. 19 shows a perspective view of a power base 706 of a liquid heating appliance in accordance with another embodiment of the present invention. The power base 706 may receive a liquid vessel 4 of the type described above. The power base 706 comprises a user interface 708 which comprises a rotatable ring 710 which is arranged to rotate 360 degrees around the power base 706 (and thus the appliance). Additionally, as shown, in some embodiments, the user interface 708 may comprise an input means 712 which may comprise at least one, e.g. a plurality of, buttons. As depicted, in some embodiments, the input means 712 may be arranged on an upper portion 716 of a main body of the power base 706.

FIG. 20 shows the power base 706 of FIG. 19 with the upper portion 716 and associated components removed to reveal some of the inner components of the power base 706. Unlike previous embodiments where the rotation of the rotatable ring was limited to a certain angular extent, in the embodiment shown in FIG. 20, the rotatable ring 710 is free to rotate 360 degrees around the power base 706. As depicted, the rotatable ring 710 engages a detection means 746, which may be in the form of a rotary encode 746, e.g. a rotary potentiometer. Teeth 744 on the rotatable ring 710 engage teeth 746A on the rotary encoder 746, causing a wheel 746B (on which the teeth 746A are arranged) of the rotary encoder 746 to rotate. A resistance to rotation of the wheel 746B, of rotary encoder 746, may at least partially determine the force required to rotate the rotatable ring 710.

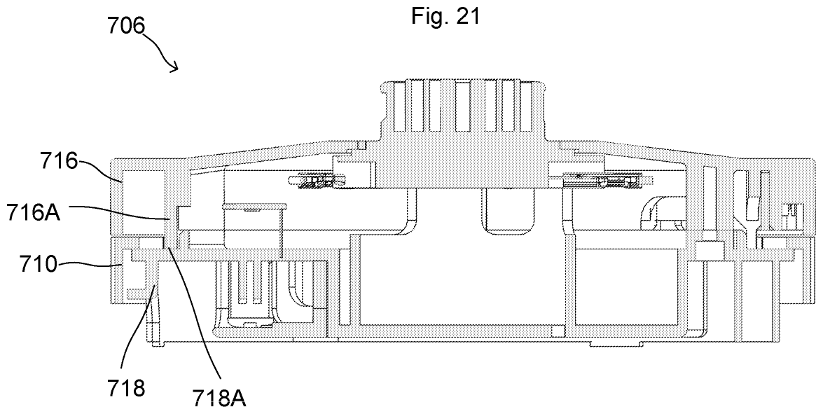

FIG. 21 shows a cross-sectional view through the power base 706 shown in FIGS. 20 and 21. As visible in this Figure, in some embodiments, the power base 706 comprises an upper portion 716 and a lower portion 718. The upper portion 716 may be configured to receive the liquid vessel thereon during use. In some embodiments, as depicted, the upper portion 716 may be configured to direct vertical force (provided thereto by the weight of the liquid vessel when arranged thereon), to the lower portion 718, without transferring any such vertical force to the rotatable ring 710. As depicted, this may be achieved by the upper portion 716 being arranged to rest directly on the lower portion 718, without acting through the rotatable ring 710. For example, a support structure 716A of the upper portion 716 may rest on the lower portion 718, e.g. an upper surface 718A thereof. The rotatable ring 710 may then be arranged such that no (or at least minimal) vertical force from the upper portion 716 is transferred thereto when a liquid vessel is arranged on the power base 706. This may ensure that the rotatable ring 710 remains free to rotate, even when a vessel is arranged on the power base 706.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A liquid heating appliance comprising:
a liquid vessel;
a power base configured to supply electrical power to the liquid vessel when the vessel is arranged thereon; and
a user interface, for setting an operational mode of the liquid heating appliance, comprising:
a rotatable ring which extends 360 degrees around the liquid heating appliance; and
a detection means configured to detect the position of the rotatable ring;
wherein the position of the rotatable ring determines the operational mode of the liquid heating appliance.

2. The liquid heating appliance of claim 1, wherein the operational mode of the appliance comprises at least one of: a temperature mode, a keep warm mode, and a heat and cool mode.

3. The liquid heating appliance of claim 1, wherein the rotatable ring is arranged on the power base and arranged to rotate around the power base.

4. The liquid heating appliance of claim 3, wherein the rotatable ring at least partially defines a recess in the power base and wherein said recess is shaped to receive a lower part of the liquid vessel when the liquid vessel is arranged on the power base.

5. The liquid heating appliance of claim 1, the power base comprises a main body, and wherein an upper portion of the main body is arranged above the rotatable ring so as to contact the liquid vessel when the liquid vessel is arranged on the power base.

6. The liquid heating appliance of claim 1, wherein at least the rotatable ring is arranged on the liquid vessel.

7. The liquid heating appliance of claim 6, wherein the rotatable ring is arranged at a lower end of the liquid vessel or an upper end of the liquid vessel.

8. The liquid heating appliance of claim 6, the liquid vessel comprises a main body, and wherein a portion of the main body is arranged below the rotatable ring so as to contact the power base when the liquid vessel is arranged thereon.

9. (canceled)

10. The liquid heating appliance of claim 1, wherein the rotatable ring is configured to rotate 360 degrees around the liquid heating appliance.

11. The liquid heating appliance of claim 1, wherein the rotatable ring is restricted to be capable of rotating up to 180 degrees, e.g. up to 135 degrees, e.g. up to 90 degrees, around the liquid heating appliance

12. The liquid heating appliance of claim 1, wherein the user interface further comprises an input means configured to control of the operation of the liquid heating appliance.

13. The liquid heating appliance of claim 12, wherein the input means is arranged to rotate with the rotatable ring.

14. (canceled)

15. The liquid heating appliance of claim 12, wherein the input means is separate to the rotatable ring and is in a fixed position on the liquid heating appliance.

16. (canceled)

17. The liquid heating appliance of claim 1, wherein an outer surface of the rotatable ring and an outer surface of the appliance adjacent the rotatable ring are flush with one another.

18. The liquid heating appliance of claim 1, wherein the rotatable ring protrudes outwards further than an outer surface of a wall of the appliance which adjacent the rotatable ring.

19. The liquid heating appliance of claim 1, wherein the user interface further comprises an indicator means configured to indicate the operational mode selected by the rotatable ring.

20. The liquid heating appliance of claim 19, wherein the indicator means is arranged to rotate with the rotatable ring.

21. The liquid heating appliance of claim 19, wherein the indicator means is separate to the rotatable ring and in a fixed position on the liquid heating appliance.

22-24. (canceled)

25. The liquid heating appliance of claim 1, further comprising at least one resilient member arranged to act between the rotatable ring and an adjacent part of the appliance which the rotatable ring is arranged next to.

26. A liquid heating appliance comprising:
a liquid vessel;
a user interface, for setting an operational mode of the liquid heating appliance; comprising:
a rotatable ring which extends 360 degrees around the liquid heating appliance; and
a detection means configured to detect the position of the rotatable ring;
wherein the position of the rotatable ring determines the operational mode of the liquid heating appliance.
